(19) United States
(12) Patent Application Publication
(10) Pub. No.: US 2002/0152238 A1
(43) Pub. Date: Oct. 17, 2002

(54) System and method to provide information corresponding to hyperlinked text in an online HTML document

(76) Inventor: Todd R. Hayes, Reston, VA (US)

Correspondence Address: Richard C. Litman, LITMAN LAW OFFICES, LTD., P.O. Box 15035, Arlington, VA, 22215, US

(21) Appl. No.: 09/835,591

(22) Filed: Apr. 17, 2001

(51) Int. Cl. G06F 15/00

(52) U.S. Cl. 707/513

(57) ABSTRACT

A system and method to provide information corresponding to hyperlinked text in an online hypertext markup language (HTML) document for a plurality of customers and users. The system is made up of a client computer means for the plurality of users to access the system, a server computer means for providing the plurality of users with the online HTML document and the client computer means communicating with the server computer means over a computer network, such as the Internet. There is also an interactive interface made up of a display frame with a static HTML layer for pop-up footnotes, graphics and banners; a scrolling text frame for holding a text of the document and hyperlinks to activate pop-up footnotes and ad banners in the display frame; a title navigation frame, which includes links to other chapters and segments of the document and a custom client frame, which is a frame that is designed to a customer's specification and includes links to a customer's Web pages. Methods are also described to roll over a hyperlink and to click onto a hyperlink to gain access to additional information and a Web site.

### BACKGROUND OF THE INVENTION

1. Field of the Invention

The present invention relates to a system and method to provide information corresponding to hyperlinked text in an online hypertext markup language (HTML) document.

2. Description of the Related Art

The Internet is a world-wide network of cooperating computer networks. Connected to the Internet are thousands of individual computers, each with a variety of application programs. From a user's point of view, access to the Internet and its services typically are accomplished by invoking a network application program (for example, a browser). The network application program acts as an interface between the user and the Internet. Network application programs are typically client applications that accept commands from the user and obtain Internet data and services by sending requests to server applications on other computers at other locations on the Internet.

HTTP is a protocol used to access data on the World Wide Web. The World Wide Web is an information service on the Internet containing electronic documents created in hypertext markup language (HTML). HTML allows embedded links or uniform resource locators (URLs) to point to other data or electronic documents, which may be found on the local computer or other remote Internet or intranet host computers. HTML document links may retrieve the data by use of HTTP or other Internet protocols. HTML documents are electronic documents that typically contain text, graphical images, animation sequences, audio and video clips and other information that is displayed by a network browser on a display device for a user.

HTML allows the author of a document to split the information displayed by a network browser into a number of rectangular areas called frames. HTML frames are created with the HTML <FRAME> and <FRAMESET> tags, which are known to those skilled in the art. Each frame can then separately display a HTML document or other HTML object (for example, a photographic image) specified by a separate URL. For example, an author can create multiple frames to display text in one frame, a photographic image in another and an animated sequence in a third frame. Authors can also specify a frame specifically for the purpose of navigational elements such as graphical toolbars. Clicking on the graphical toolbar frames with a mouse or other pointing device will update the content of other frames displayed.

U.S. Pat. No. 5,987,482 issued to Bates et al. outlines the use of a method of displaying a hypertext document including an internal hypertext link definition linked to a predetermined location therein.

U.S. Pat. No. 6,031,989 issued to Cordell relates to formatting and displaying information contained within a document obtained from a computer network. More specifically, the invention relates to formatting text, graphical images and other information for an electronic document nested with a main electronic document used on computer networks like the Internet.

U.S. Pat. No. 6,065,024 issued to Renshaw relates to embedded HTML documents and to a method and system for rendering such documents to a visual display unit. The invention utilizes a Java applet which can be launched by a Java enabled browser. The Java applet can parse and render HTML instructions contained within an HTML document to a reserved area of a visual display unit. The Java applet can also launch further applets and therefore allow further nesting or embedding of HTML documents.

U.S. Pat. No. 6,101,510 issued to Stone et al. relates to computer software for browsing computer networks, such as the Internet or an intranet. More specifically, the invention relates to software to incorporate web browsing functionality into application programs.

U.S. Pat. No. 6,112,203 issued to Bharat et al. outlines a method for ranking documents in a hyperlinked environment using connectivity and selective content analysis. Specifically, a set of documents are ranked according to their content and their connectivity by using topic distillation. The documents include links that connect the documents to each other either directly or indirectly. A graph is also constructed in a memory of a computer system.

U.S. Pat. No. 6,119,135 issued to Helfman outlines the use of a technique for passively browsing the Internet or an intranet by displaying images from Web pages on a user's display screen. The user can select an image by clicking on it using a pointer manipulated by a mouse or trackball. A mapping list is maintained that maps the image universal resource locator (URL) for each image to the URL of the Web page containing the image.

U.S. Pat. No. 6,121,970 issued to Guedalia outlines a method for archiving digital data on a server computer and enabling a user, by means of a client computer, to interactively view a digital image derived from the digital data, including receiving by the client computer from the server computer, an HTML page. The HTML page includes a view window within which a first image is displayed, the view window being partitioned into a plurality of imaginary sub-regions, at least one of which contains a multiplicity of pixels, selecting by the user, using a pointing device, a location within the view window corresponding to one of the plurality of sub-regions.

U.S. Pat. No. 6,141,018 issued to Beri et al. outlines the use of a computer system for displaying an image of a hypertext document in an animated marquee. The computer system includes a hypertext document viewer that receives an identification of a hypertext document and generates an image of the hypertext document.

There is a lot of technology related to HTML pages and pop-up footnotes. Footnotes are activated by a user rolling over hyperlinks in an online document. When a user rolls his cursor over hyperlinked text, an image in a specified layer is replaced with a footnote corresponding to the text link. Other technology includes using footnotes similarly by using a click link to open a new HTML window with footnote information.

This application outlines a different and novel technology in that the footnotes are embedded on the same Web page as the text of the document, and all footnotes appear in the same layer on the page, requiring no new HTML windows to be opened. Current technology requires a new HTML window to be opened when using hyperlinked footnotes, which is not as desirable as the described system and method.

None of the above inventions and patents, taken either singularly or in combination, is seen to describe the instant invention as claimed.

### SUMMARY OF THE INVENTION

The invention is a system and method to provide information corresponding to hyperlinked text in an online hypertext markup language (HTML) document for a plurality of customers and users. The system is made up of a client computer means for the plurality of users to access the system, a server computer means for providing the plurality of users with the online HTML document, and the client computer means communicating with the server computer means over a computer network, such as the Internet. There is also an interactive interface made up of a display frame with a static HTML layer for pop-up footnotes, graphics and banners; a scrolling text frame for holding a text of the document, and hyperlinks to activate pop-up footnotes and ad banners in the display frame; a title navigation frame, which includes links to other chapters and segments of the document; and a custom client frame, which is a frame that is designed to a customer's specification and includes links to a customer's Web pages. Methods are also described to roll over a hyperlink and to click onto a hyperlink to gain access to additional information and a Web site.

Accordingly, it is a principal object of the invention to utilize footnotes that are embedded on the same Web page as the text of the document; all footnotes appear in the same layer on the page, requiring no new HTML windows to be opened.

It is another object of the invention to utilize hyperlinked underlined words in the text frame of an online document to activate a footnote when a user rolls a cursor over the hyperlink.

It is a further object of the invention to display supplementary in a specific layer of the same HTML frameset window.

Still another object of the invention is to allow a user to click onto the hyperlinked text to open a new HTML window to a Web site of related interest.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an overview of the system to provide information corresponding to hyperlinked text in an online hypertext markup language (HTML) document.

FIGS. 2A and 2B are an overview of the overall two methods to provide information corresponding to hyperlinked text in an online hypertext markup language (HTML) document.

FIG. 3A is a display for pop-up footnotes, graphics and ad banners in a static HTML layer, according to the present invention.

FIG. 3B is a scrolling text display with hyperlinks, according to the present invention.

FIG. 4 is a title image displayed in a static HTML layer, according to the present invention.

FIG. 5A is a footnote displayed in a static HTML layer during mouse rollover, according to the present invention.

FIG. 5B is an ad banner displayed in a static HTML layer during mouse rollover, according to the present invention.

FIG. GA is a Web site complementing footnote in new window opened by clicking hyperlink.

FIG. 6B is a sponsor's Web site in new window opened by clicking hyperlink.

FIG. 7 is a title navigation frame displayed, according to the present invention.

FIG. 8 is a custom dealer/library frame displayed, according to the present invention.

FIG. 9 is an identifying HTML address code sample, according to the present invention.

Similar reference characters denote corresponding features consistently throughout the attached drawings.

### DETAILED DESCRIPTION OF THE PREFERRED EMBODIMENT

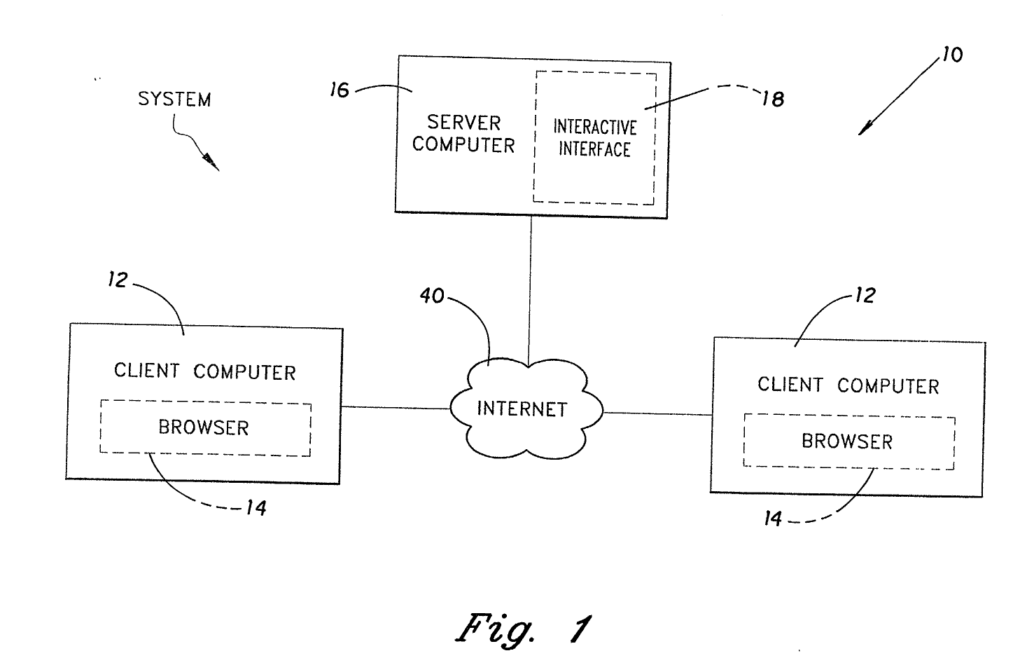

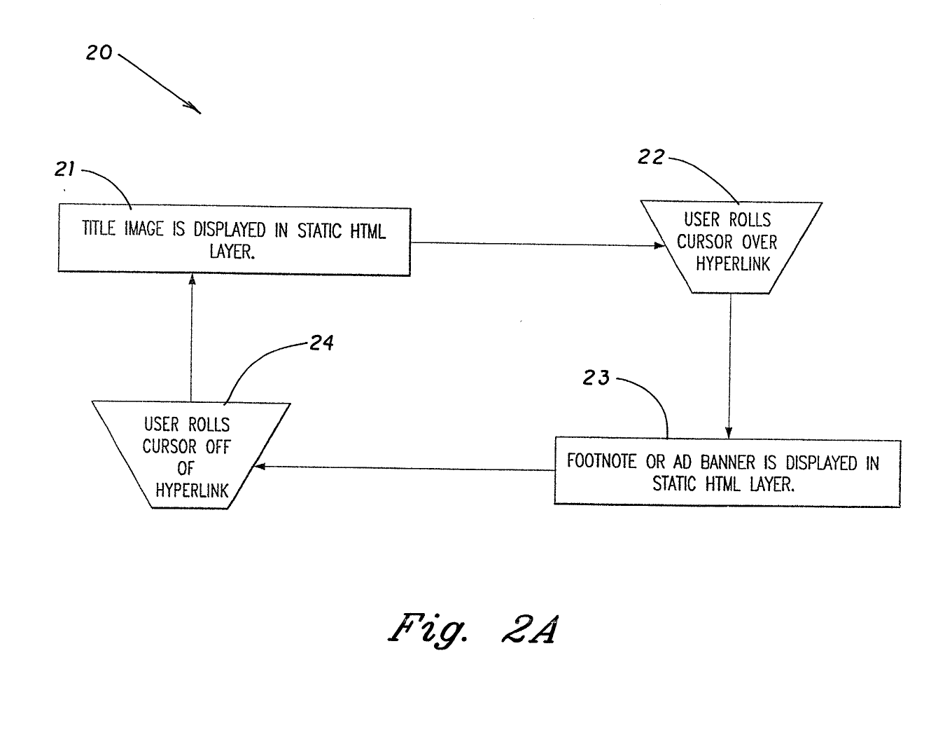

The present invention is a system 10 to provide information corresponding to hyperlinked text in an online hypertext markup language (HTML) document for a plurality of customers and users. FIG. 1 depicts the overall system 10 and is comprised of a client computer means 12 and browser 14 for the plurality of users to access the system 10 and a server computer means 16 for providing the plurality of users with the online HTML document.

The client computer means 12 communicates with the server computer means 16 over a computer network, such as the Internet 40. The server computer means 16 also utilizes an interactive interface 18 which allows customers and users access to the interactive interface 18 from their respective client computer 12.

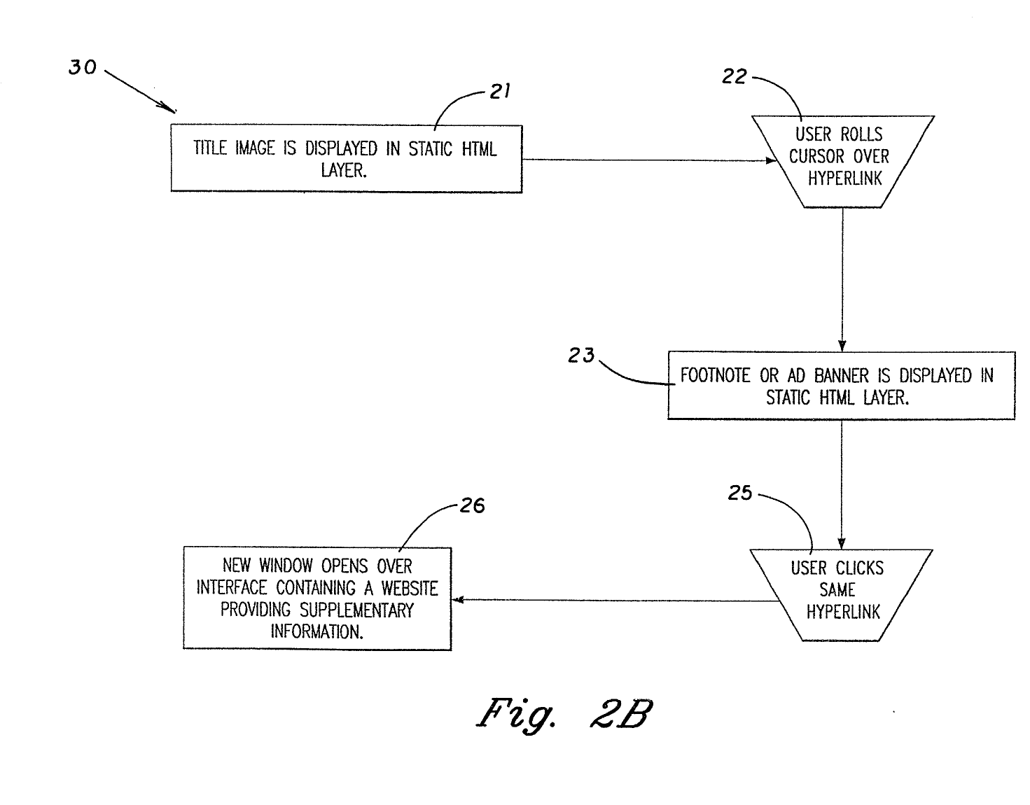

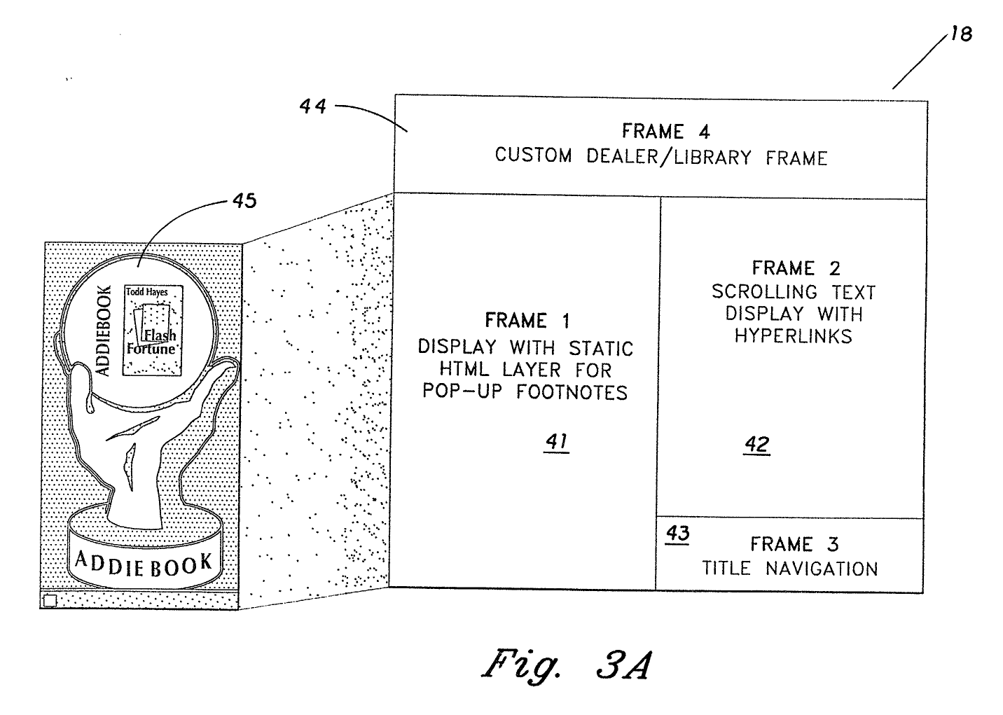

There are 2 methods outlined with the use of this invention, which are depicted in FIGS. 2A,2B. The first method 20 involves a user rolling his cursor over a hyperlink corresponding to hyperlinked text in an online hypertext markup language (HTML) document. These steps involve displaying a dormant title image in a display frame 21, rolling a cursor from a pointing device over a hyperlink in a scrolling text frame 22, displaying a footnote or an ad banner in a display frame 23, rolling a cursor from a pointing device off of a hyperlink in a scrolling text frame 24 and displaying a dormant title image again in a display frame 21.

The second method 30 involves a user clicking his cursor on a hyperlink corresponding to hyperlinked text in an online hypertext markup language (HTML) document. These steps involve displaying a dormant title image in a display frame 21, rolling a cursor from a pointing device over a hyperlink in a scrolling text frame 22, displaying a footnote and an ad banner in a display frame 23, clicking on the hyperlink in a scrolling text frame 25 and opening a new window over the interactive interface 18 containing a Web site providing supplementary information 26. This second method 30 is depicted in FIG. 2B.

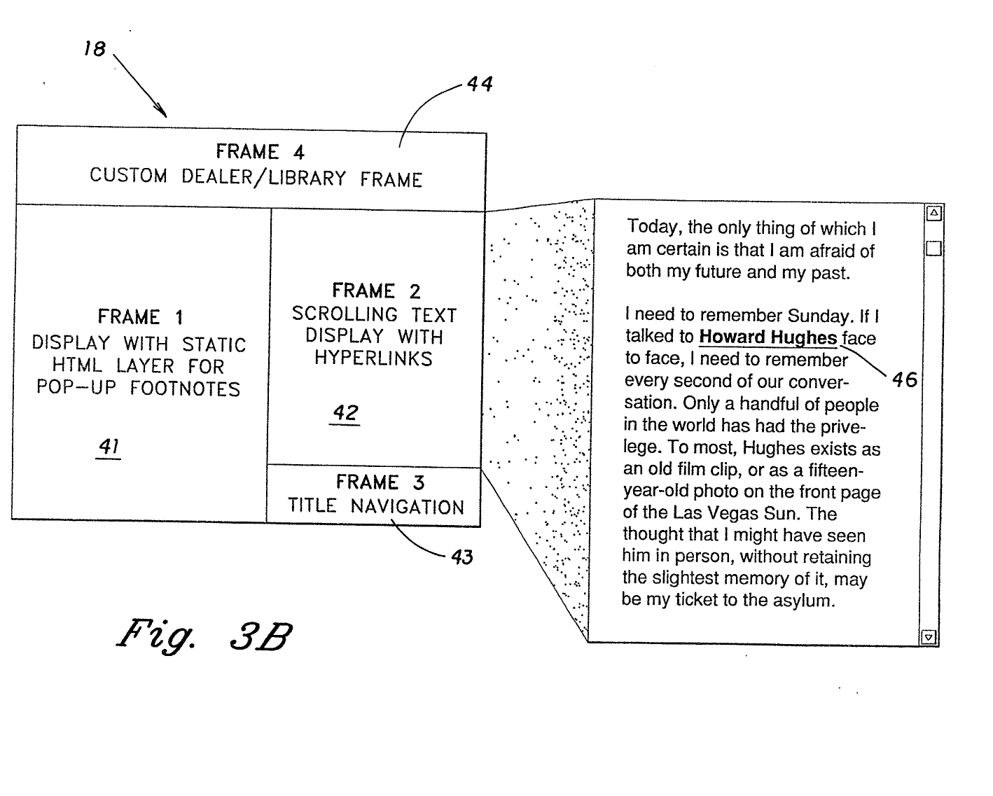

FIG. 3A depicts an interactive interface 18 comprising a display frame 41 with a static HTML layer for pop-up footnotes, graphics and banners, a scrolling text frame 42 for holding a text of the document and hyperlinks to activate pop-up footnotes and ad banners in the display frame, a title navigation frame 43, which includes links to other chapters and segments of the document and a custom client frame 44, which is a frame that is designed to a customer's specification and includes links to a customer's Web pages.

The static HTML frame 41 of the interactive interface 18 contains a static HTML layer, where all footnotes, graphics and ad banners corresponding to the hyperlinks in the scrolling text frame 42 are displayed. When dormant, the static HTML frame 41 displays the document title and cover art. When activated by a mouse rollover on a hyperlink in the scrolling text frame 42, the static HTML frame 41 displays information corresponding to the hyperlinked text in the form of a 125×125 pixel graphics interchange format (GIF) file 45. When a user rolls his cursor off of the hyperlink, the static HTML frame 41 resumes its dormant position by displaying the document title and cover art.

There are several unique properties of the interactive interface 18. The static HTML frame 41 is a static element for displaying footnotes in an online HTML document. All hyperlinks from the scrolling text frame 42 have a corresponding rollover-activated complement in the static HTML frame 41. The static HTML frame 41 displays all information in the form of 125x125 GIF files 45, including text, graphics and ad banners.

The contents of the static HTML frame 41 remain visible in the same HTML window on the interactive interface 18 throughout a user's session. Footnotes and ads displayed in the static HTML frame 41 are further complemented by click links from the same hyperlinked text, which can also open new windows to corresponding Web pages and Web sites (not shown).

The scrolling text frame 42 holds the text of each document in the format in a scrolling frame, as shown in FIG. 3B. Hyperlinks 46, which activate both rollover links to activate corresponding footnotes in the static HTML frame 41 and click to open separate Web pages, are embedded in this frame and are identified by highlighted underlined words 46 in the scrolling text frame 42.

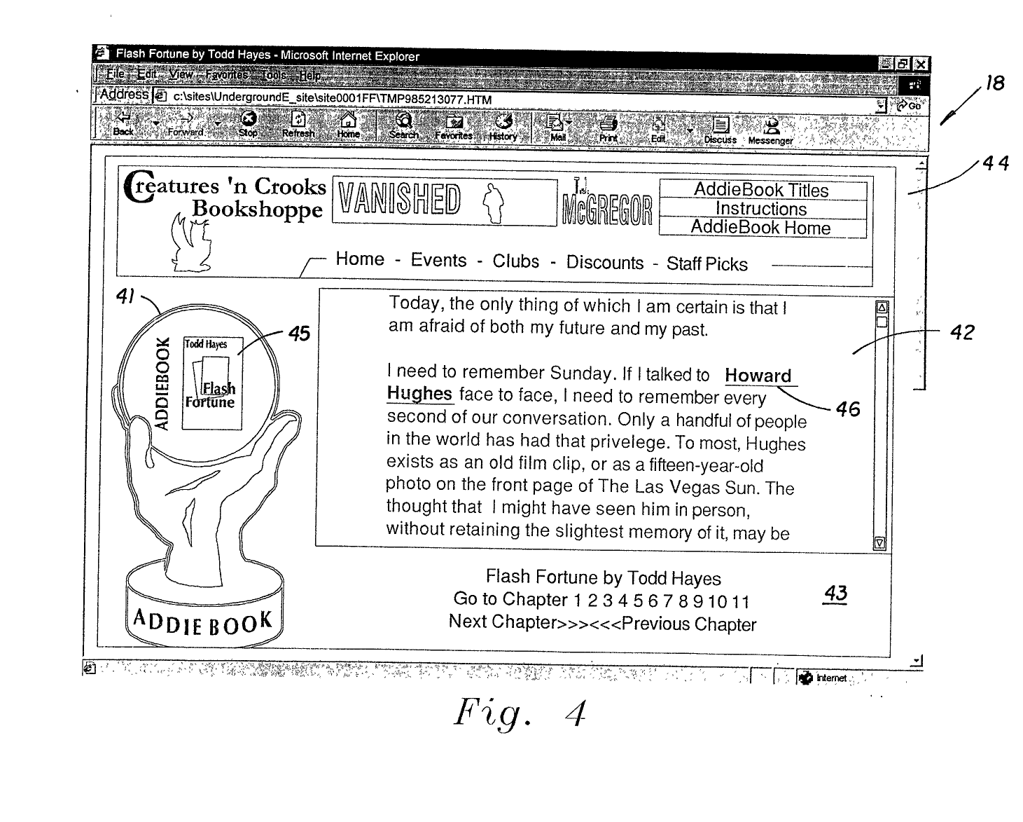

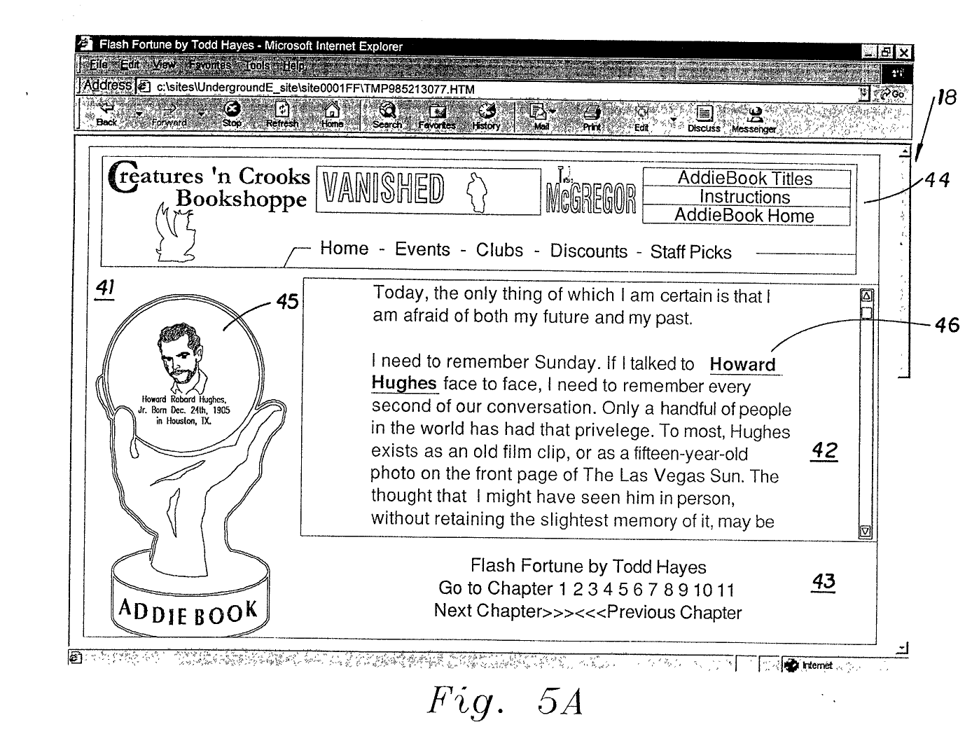

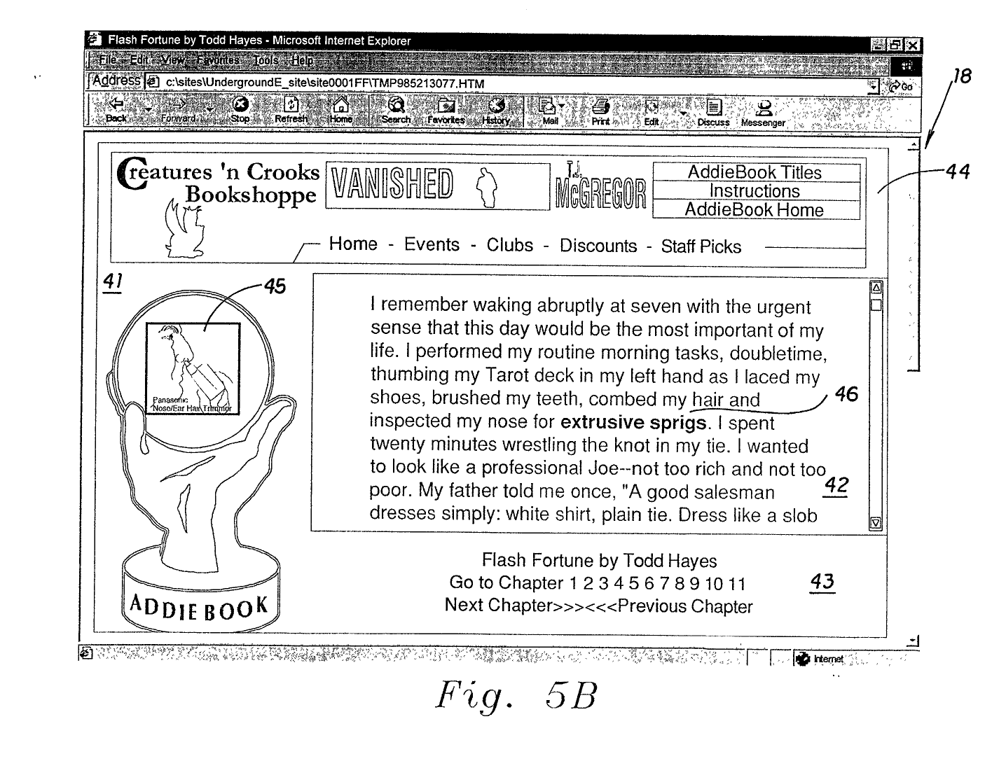

FIG. 4 illustrates a dormant interaction interface 18 sample before any interactivity. The title image display 45 appears in the static HTML frame 41 as a GIF file 45. FIG. 5A illustrates a user activating a hyperlink 46 by rolling his cursor over the hyperlink 46, thereby activating the corresponding GIF file 45 in the static HTML frame 41. FIG. 5B illustrates a user activating a hyperlink 46 ad banner by rolling his cursor over the hyperlink 46, thereby activating the same corresponding GIF file 45 in the static HTML frame 41.

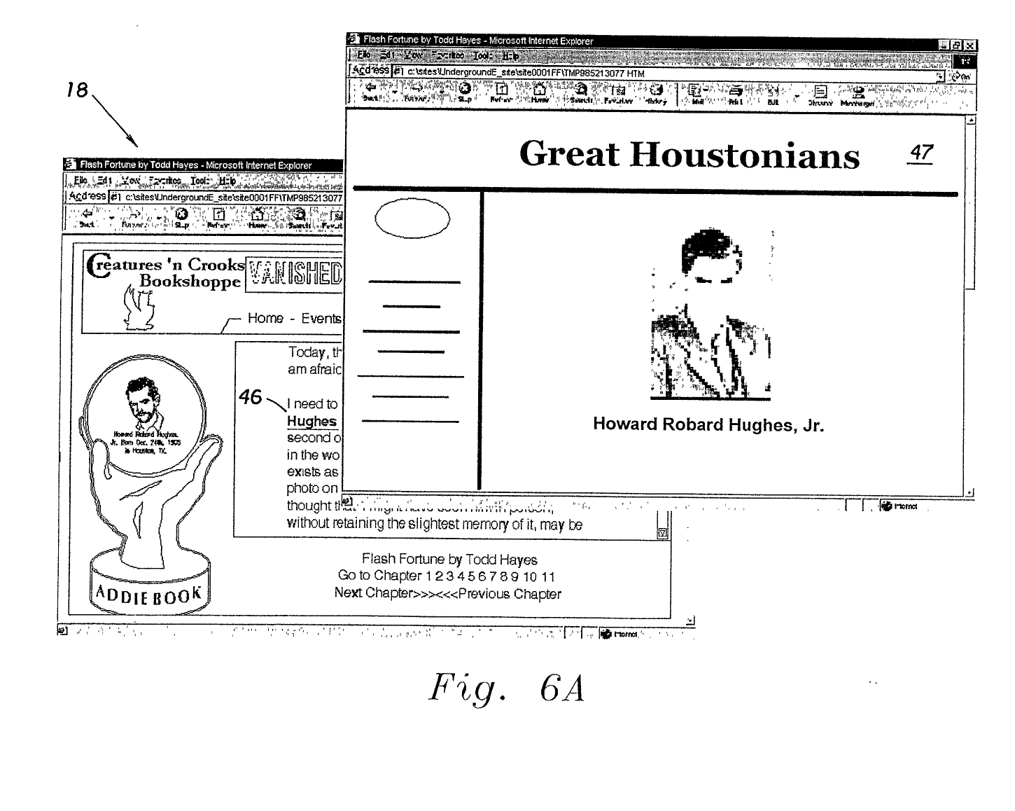

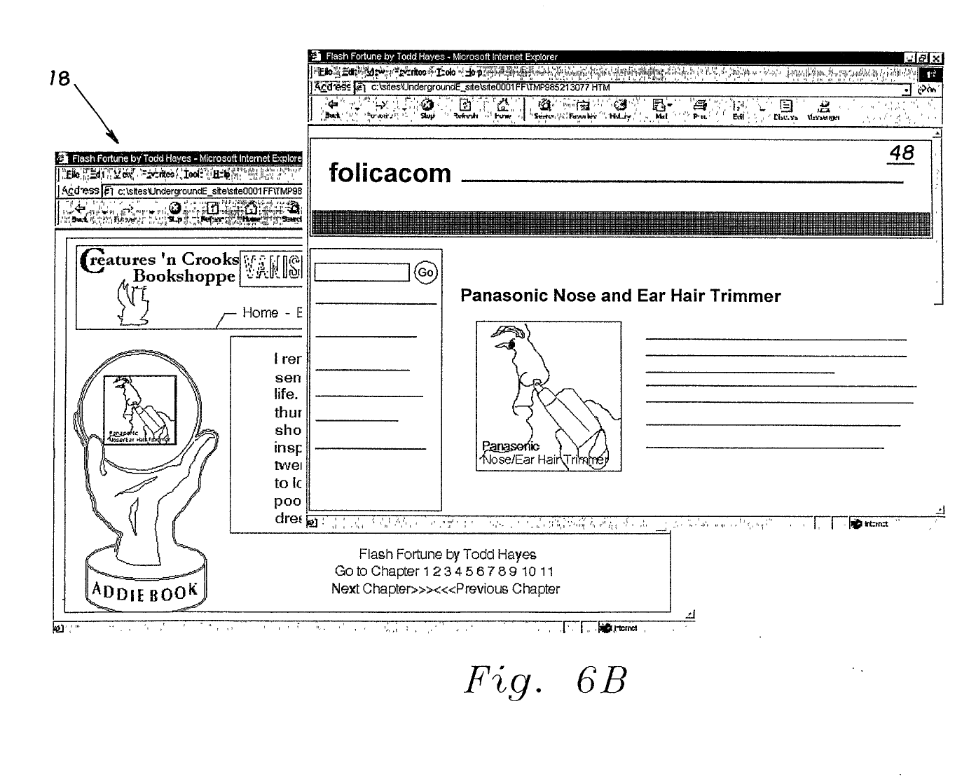

FIG. 6A illustrates a new Web page opened by clicking onto the hyperlink 46 in front of the interactive interface 18 to supply additional information related to the Web site complementing footnote 47 in the static HTML frame 41. Note that there is a distinction between rolling over a hyperlink 46 (which was previously done) and clicking onto a hyperlink 46. Similarly in FIG. 6B, a sponsor's Web site opens in another new window 48 by clicking the hyperlink 46 for the ad banner.

This system 10 is for the repetitive use of an online HTML electronic book presentation or document, in which footnotes, graphics and sponsored information are displayed (in the form of GIF files 45) in the same interactive interface 18 for each hyperlink 46, while click-linking to tangent Web pages 47,48 using the same hyperlink 46 as the one used for the rollover links.

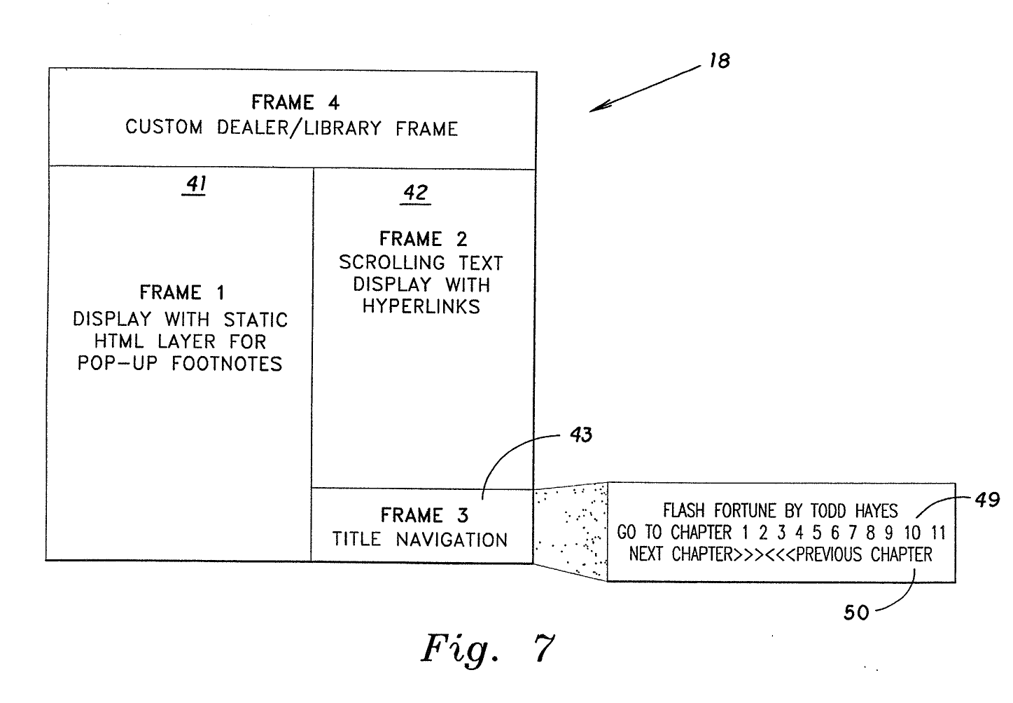

FIG. 7 is the title navigation frame 43, that includes links to other chapters or segments in the document presented. Upon clicking a go to chapter link 49 or a next/previous link 50, a new interactive interface 18 is displayed. The title navigation frame 43 changes to a navigation frame relevant to the chosen chapter or segment. The scrolling text frame 42 is then updated with the text for the chosen chapter and the associated rollover images that will appear in the static HTML frame 41 for the chosen chapter (if activated), which are then preloaded into the user's browser cache (not shown).

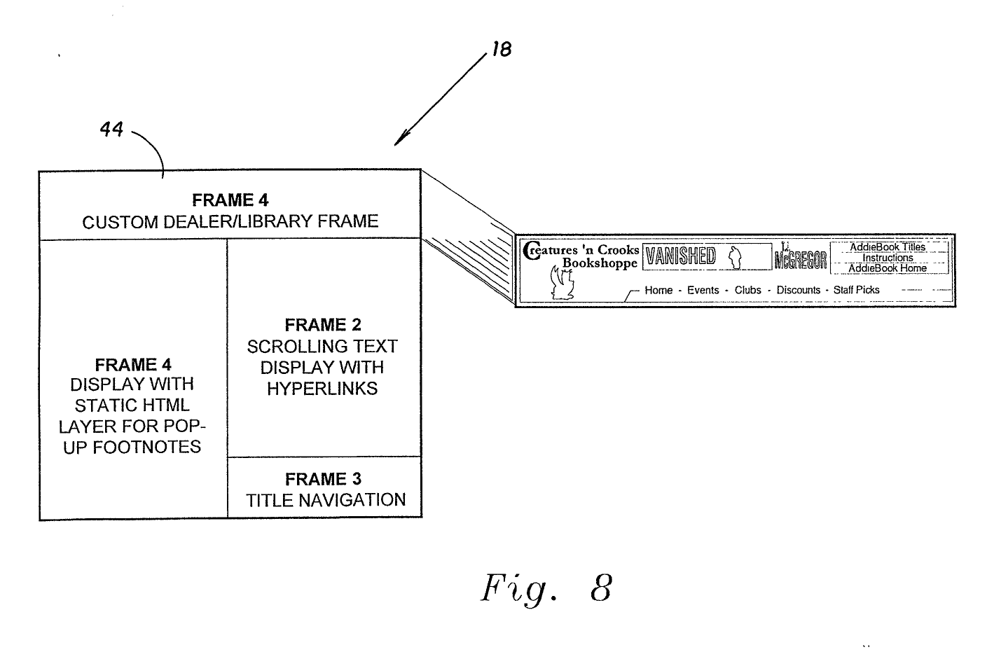

Each interactive interface 18 viewed by an online user will include a custom dealer/library frame or custom client frame 44, as shown in FIG. 8. Custom client frames 44 are designed individually for booksellers, libraries and other institutions who are providing titles in this format to users. Users who purchase or borrow a title from a particular dealer or library will always see the corresponding custom client frame 44 as a shell for the title, which can lead them back to their provider's Web site (as previously shown). Custom client frames 44 are 634×117 pixels in size and include links to specified client Web pages. Custom client frames 44 may or may not include standard 480×60 pixel banner ads with links to sponsor sites, depending on the client's preference.

While other Internet applications, especially search-engine services, use shared frames to navigate the Web, the custom client frames in this format are custom-made exclusively for dealers and institutions who have purchased access rights from the publisher for a particular online electronic book or document, and who plan to resell access to customers or to provide access for members and patrons of their organization. The custom client frame 44 is an indicator of a rightful distributing entity for any given title in the format.

The link references and the HTML address codes 51 catalogued for the electronic books and documents in this format are dependent upon the title identifier 52, chapter or segment identifier 53 and the dealer/library provider identifier 54 to open the proper frameset window for the user.

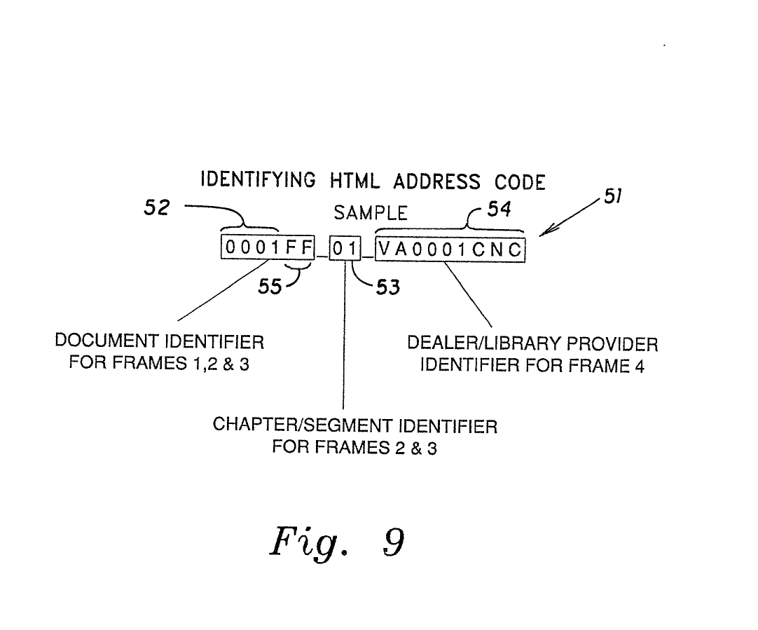

As shown in FIG. 9, the title identifier 52 is a four-digit code describing the order in which the title was published and a two-letter code 55 abbreviation for the title. The chapter or segment identifier 53 is a two-digit code. The dealer/library provider identifier 54 is a 9-character code referencing the general location and client number particular to a custom client frame 44. The first two letters of the client code reference the state or province in which the client resides; the next four digits identify the client number within that state or province and the last three characters are an abbreviation for the client's name.

The name of the frameset in FIG. 9 is 00001FF_{—}01_VA001CNC, which references the title, the chapter and the client provider. By clicking a link from a client Web site or from the publisher's Web site, the proper frameset appears in an HTML window. The full URL for this sample would include the publisher's Web site address followed by the name of the frameset and the HTML document extension. For example, http://www.addiebooks.com/0001FF_{—}01_VA0001CNC.htm would take the user to the first chapter of the referenced title with a referenced client frame appearing on top of the page.

It is to be understood that the present invention is not limited to the embodiment described above, but encompasses any and all embodiments within the scope of the following claims.

I claim:

1. A system to provide information corresponding to hyperlinked text in an online hypertext markup language (HTML) document for a plurality of customers and users, comprising:
a client computer means for the plurality of users to access the system;
a server computer means for providing the plurality of users with the online HTML document, said client computer means communicating with said server computer means over a computer network, such as the Internet; and
an interactive interface comprising:
a display frame with a static HTML layer for pop-up footnotes, graphics and banners;
a scrolling text frame for holding a text of the document and hyperlinks to activate pop-up footnotes and ad banners in the display frame;
a title navigation frame, which includes links to other chapters and segments of the document; and
a custom client frame, which is a frame that is designed to a customer's specification and includes links to a customer's Web pages.

2. The system according to claim 1, wherein an identifying HTML address code comprises a document identifier, a chapter and segment identifier and a custom client identifier.

3. A method to provide information corresponding to hyperlinked text in an online hypertext markup language (HTML) document for a plurality of customers and users, comprising:
displaying a dormant title image in the display frame;
rolling a cursor from a pointing device over a hyperlink in the scrolling text frame;
displaying a footnote and an ad banner in the display frame;
rolling a cursor from a pointing device off of a hyperlink in the scrolling text frame; and
displaying a dormant title image again in the display frame.

4. A second method to provide information corresponding to hyperlinked text in an online hypertext markup language (HTML) document for a plurality of customers and users, comprising:
displaying a dormant title image in the display frame;
rolling a cursor from a pointing device over a hyperlink in the scrolling text frame;
displaying a footnote and an ad banner in the display frame;
clicking on the hyperlink in the scrolling text frame; and
opening a new window over the interactive interface containing a Web site providing supplementary information.
